(19) United States
(12) Patent Application Publication
(10) Pub. No.: US 2016/0135103 A1
(43) Pub. Date: May 12, 2016

(54) METHOD AND APPARATUS FOR PERFORMING HANDOVER PROCEDURE FOR DUAL CONNECTIVITY IN WIRELESS COMMUNICATION SYSTEM

(71) Applicant: LG ELECTRONICS INC, Seoul (KR)

(72) Inventors: Insun Lee, Seoul (KR); Daewook Byun, Seoul (KR); Jian Xu, Seoul (KR); Kyungmin Park, Seoul (KR)

(21) Appl. No.: 14/896,731

(22) PCT Filed: Jul. 17, 2014
(86) PCT No.: PCT/KR2014/006495

§ 371 Date: Dec. 8, 2015

Related U.S. Application Data
(60) Provisional application No. 61/847,095, filed on Jul. 17, 2013.

(51) Int. Cl. H04W 36/22; H04W 72/04; H04W 76/04; H04W 28/08

(52) U.S. Cl. CPC H04W 36/22; H04W 28/08; H04W 72/0406; H04W 76/046

(57) ABSTRACT

A method and apparatus for performing a handover procedure in a wireless communication system is provided. A master eNodeB (MeNB), in dual connectivity, performs a handover decision from a source secondary eNB (SeNB) to a target SeNB, and transmits an offloading request message, which includes contexts of E-UTRAN radio access bearers (E-RABs) to be offloaded and an offloading indication, to the target SeNB. The MeNB receives an offloading request acknowledge message, which includes identifiers (IDs) of E-RABs accepted by the target SeNB, as a response to the offloading request message from the target SeNB, and transmits an offloading mobility indication to a user equipment (UE).

### BACKGROUND OF THE INVENTION

1. Field of the Invention

The present invention relates to wireless communications, and more particularly, to a method and apparatus for performing a handover procedure for dual connectivity in a wireless communication system.

2. Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), a base transceiver system (BTS), an access point, etc. One eNB 20 may be deployed per cell. There are one or more cells within the coverage of the eNB 20. A single cell is configured to have one of bandwidths selected from 1.25, 2.5, 5, 10, and 20 MHz, etc., and provides downlink or uplink transmission services to several UEs. In this case, different cells can be configured to provide different bandwidths.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) which is in charge of control plane functions, and a system architecture evolution (SAE) gateway (S-GW) which is in charge of user plane functions. The MME/S-GW 30 may be positioned at the end of the network and connected to an external network. The MME has UE access information or UE capability information, and such information may be primarily used in UE mobility management. The S-GW is a gateway of which an endpoint is an E-UTRAN. The MME/S-GW 30 provides an end point of a session and mobility management function for the UE 10. The EPC may further include a packet data network (PDN) gateway (PDN-GW). The PDN-GW is a gateway of which an endpoint is a PDN.

The MME provides various functions including non-access stratum (NAS) signaling to eNBs 20, NAS signaling security, access stratum (AS) security control, Inter core network (CN) node signaling for mobility between 3GPP access networks, idle mode UE reachability (including control and execution of paging retransmission), tracking area list management (for UE in idle and active mode), P-GW and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on APN-AMBR. For clarity MME/S-GW 30 will be referred to herein simply as a “gateway,” but it is understood that this entity includes both the MME and S-GW.

Interfaces for transmitting user traffic or control traffic may be used. The UE 10 and the eNB 20 are connected by means of a Uu interface. The eNBs 20 are interconnected by means of an X2 interface. Neighboring eNBs may have a meshed network structure that has the X2 interface. The eNBs 20 are connected to the EPC by means of an S1 interface. The eNBs 20 are connected to the MME by means of an S1-MME interface, and are connected to the S-GW by means of S1-U interface. The S1 interface supports a many-to-many relation between the eNB 20 and the MME/S-GW.

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

FIG. 3 shows a block diagram of a user plane protocol stack and a control plane protocol stack of an LTE system. FIG. 3-(a) shows a block diagram of a user plane protocol stack of an LTE system, and FIG. 3-(b) shows a block diagram of a control plane protocol stack of an LTE system.

Layers of a radio interface protocol between the UE and the E-UTRAN may be classified into a first layer (L1), a second layer (L2), and a third layer (L3) based on the lower three layers of the open system interconnection (OSI) model that is well-known in the communication system. The radio interface protocol between the UE and the E-UTRAN may be horizontally divided into a physical layer, a data link layer, and a network layer, and may be vertically divided into a control plane (C-plane) which is a protocol stack for control signal transmission and a user plane (U-plane) which is a protocol stack for data information transmission. The layers of the radio interface protocol exist in pairs at the UE and the E-UTRAN, and are in charge of data transmission of the Uu interface.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data is transferred between the MAC layer and the PHY layer through the transport channel. Between different PHY layers, i.e., a PHY layer of a transmitter and a PHY layer of a receiver, data is transferred through the physical channel using radio resources. The physical channel is modulated using an orthogonal frequency division multiplexing (OFDM) scheme, and utilizes time and frequency as a radio resource.

The PHY layer uses several physical control channels. A physical downlink control channel (PDCCH) reports to a UE about resource allocation of a paging channel (PCH) and a downlink shared channel (DL-SCH), and hybrid automatic repeat request (HARQ) information related to the DL-SCH. The PDCCH may carry a UL grant for reporting to the UE about resource allocation of UL transmission. A physical control format indicator channel (PCFICH) reports the number of OFDM symbols used for PDCCHs to the UE, and is transmitted in every subframe. A physical hybrid ARQ indicator channel (PHICH) carries an HARQ acknowledgement (ACK)/non-acknowledgement (NACK) signal in response to UL transmission. A physical uplink control channel (PUCCH) carries UL control information such as HARQ ACK/NACK for DL transmission, scheduling request, and CQI. A physical uplink shared channel (PUSCH) carries a UL-uplink shared channel (SCH).

FIG. 4 shows an example of a physical channel structure.

A physical channel consists of a plurality of subframes in time domain and a plurality of subcarriers in frequency domain. One subframe consists of a plurality of symbols in the time domain. One subframe consists of a plurality of resource blocks (RBs). One RB consists of a plurality of symbols and a plurality of subcarriers. In addition, each subframe may use specific subcarriers of specific symbols of a corresponding subframe for a PDCCH. For example, a first symbol of the subframe may be used for the PDCCH. The PDCCH carries dynamic allocated resources, such as a physical resource block (PRB) and modulation and coding scheme (MCS). A transmission time interval (TTI) which is a unit time for data transmission may be equal to a length of one subframe. The length of one subframe may be 1 ms.

The transport channel is classified into a common transport channel and a dedicated transport channel according to whether the channel is shared or not. A DL transport channel for transmitting data from the network to the UE includes a broadcast channel (BCH) for transmitting system information, a paging channel (PCH) for transmitting a paging message, a DL-SCH for transmitting user traffic or control signals, etc. The DL-SCH supports HARQ, dynamic link adaptation by varying the modulation, coding and transmit power, and both dynamic and semi-static resource allocation. The DL-SCH also may enable broadcast in the entire cell and the use of beamforming. The system information carries one or more system information blocks. All system information blocks may be transmitted with the same periodicity. Traffic or control signals of a multimedia broadcast/multicast service (MBMS) may be transmitted through the DL-SCH or a multicast channel (MCH).

A UL transport channel for transmitting data from the UE to the network includes a random access channel (RACH) for transmitting an initial control message, a UL-SCH for transmitting user traffic or control signals, etc. The UL-SCH supports HARQ and dynamic link adaptation by varying the transmit power and potentially modulation and coding. The UL-SCH also may enable the use of beamforming. The RACH is normally used for initial access to a cell.

A MAC layer belongs to the L2. The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. A MAC sublayer provides data transfer services on logical channels.

The logical channels are classified into control channels for transferring control plane information and traffic channels for transferring user plane information, according to a type of transmitted information. That is, a set of logical channel types is defined for different data transfer services offered by the MAC layer. The logical channels are located above the transport channel, and are mapped to the transport channels.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting MBMS control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RLC layer belongs to the L2. The RLC layer provides a function of adjusting a size of data, so as to be suitable for a lower layer to transmit the data, by concatenating and segmenting the data received from a higher layer in a radio section. In addition, to ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides a retransmission function through an automatic repeat request (ARQ) for reliable data transmission. Meanwhile, a function of the RLC layer may be implemented with a functional block inside the MAC layer. In this case, the RLC layer may not exist.

A packet data convergence protocol (PDCP) layer belongs to the L2. The PDCP layer provides a function of header compression function that reduces unnecessary control information such that data being transmitted by employing IP packets, such as IPv4 or IPv6, can be efficiently transmitted over a radio interface that has a relatively small bandwidth. The header compression increases transmission efficiency in the radio section by transmitting only necessary information in a header of the data. In addition, the PDCP layer provides a function of security. The function of security includes ciphering which prevents inspection of third parties, and integrity protection which prevents data manipulation of third parties.

A radio resource control (RRC) layer belongs to the L3. The RLC layer is located at the lowest portion of the L3, and is only defined in the control plane. The RRC layer takes a role of controlling a radio resource between the UE and the network. For this, the UE and the network exchange an RRC message through the RRC layer. The RRC layer controls logical channels, transport channels, and physical channels in relation to the configuration, reconfiguration, and release of RBs. An RB is a logical path provided by the L1 and L2 for data delivery between the UE and the network. That is, the RB signifies a service provided the L2 for data transmission between the UE and E-UTRAN. The configuration of the RB implies a process for specifying a radio protocol layer and channel properties to provide a particular service and for determining respective detailed parameters and operations. The RB is classified into two types, i.e., a signaling RB (SRB) and a data RB (DRB). The SRB is used as a path for transmitting an RRC message in the control plane. The DRB is used as a path for transmitting user data in the user plane.

Referring to FIG. 3-(a), the RLC and MAC layers (terminated in the eNB on the network side) may perform functions such as scheduling, automatic repeat request (ARQ), and hybrid automatic repeat request (HARQ). The PDCP layer (terminated in the eNB on the network side) may perform the user plane functions such as header compression, integrity protection, and ciphering.

Referring to FIG. 3-(b), the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

An RRC state indicates whether an RRC layer of the UE is logically connected to an RRC layer of the E-UTRAN. The RRC state may be divided into two different states such as an RRC connected state and an RRC idle state. When an RRC connection is established between the RRC layer of the UE and the RRC layer of the E-UTRAN, the UE is in RRC_CONNECTED, and otherwise the UE is in RRC_IDLE. Since the UE in RRC_CONNECTED has the RRC connection established with the E-UTRAN, the E-UTRAN may recognize the existence of the UE in RRC_CONNECTED and may effectively control the UE. Meanwhile, the UE in RRC_IDLE may not be recognized by the E-UTRAN, and a CN manages the UE in unit of a TA which is a larger area than a cell. That is, only the existence of the UE in RRC_IDLE is recognized in unit of a large area, and the UE must transition to RRC_CONNECTED to receive a typical mobile communication service such as voice or data communication.

In RRC_IDLE state, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE state, no RRC context is stored in the eNB.

In RRC_CONNECTED state, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED state, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE state, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion.

A paging message is transmitted over all cells belonging to the same tracking area. If the UE moves from one TA to another TA, the UE will send a tracking area update (TAU) message to the network to update its location.

When the user initially powers on the UE, the UE first searches for a proper cell and then remains in RRC_IDLE in the cell. When there is a need to establish an RRC connection, the UE which remains in RRC_IDLE establishes the RRC connection with the RRC of the E-UTRAN through an RRC connection procedure and then may transition to RRC_CONNECTED. The UE which remains in RRC_IDLE may need to establish the RRC connection with the E-UTRAN when uplink data transmission is necessary due to a user's call attempt or the like or when there is a need to transmit a response message upon receiving a paging message from the E-UTRAN.

It is known that different cause values may be mapped o the signature sequence used to transmit messages between a UE and eNB and that either channel quality indicator (CQI) or path loss and cause or message size are candidates for inclusion in the initial preamble.

When a UE wishes to access the network and determines a message to be transmitted, the message may be linked to a purpose and a cause value may be determined. The size of the ideal message may be also be determined by identifying all optional information and different alternative sizes, such as by removing optional information, or an alternative scheduling request message may be used.

The UE acquires necessary information for the transmission of the preamble, UL interference, pilot transmit power and required signal-to-noise ratio (SNR) for the preamble detection at the receiver or combinations thereof. This information must allow the calculation of the initial transmit power of the preamble. It is beneficial to transmit the UL message in the vicinity of the preamble from a frequency point of view in order to ensure that the same channel is used for the transmission of the message.

The UE should take into account the UL interference and the UL path loss in order to ensure that the network receives the preamble with a minimum SNR. The UL interference can be determined only in the eNB, and therefore, must be broadcast by the eNB and received by the UE prior to the transmission of the preamble. The UL path loss can be considered to be similar to the DL path loss and can be estimated by the UE from the received RX signal strength when the transmit power of some pilot sequence of the cell is known to the UE.

The required UL SNR for the detection of the preamble would typically depend on the eNB configuration, such as a number of Rx antennas and receiver performance. There may be advantages to transmit the rather static transmit power of the pilot and the necessary UL SNR separately from the varying UL interference and possibly the power offset required between the preamble and the message.

The initial transmission power of the preamble can be roughly calculated according to the following formula:

Transmit power=TransmitPilot−RxPilot+ULInterference+Offset+SNRRequired

Therefore, any combination of SNRRequired, ULInterference, TransmitPilot and Offset can be broadcast. In principle, only one value must be broadcast. This is essentially in current UMTS systems, although the UL interference in 3GPP LTE will mainly be neighboring cell interference that is probably more constant than in UMTS system.

The UE determines the initial UL transit power for the transmission of the preamble as explained above. The receiver in the eNB is able to estimate the absolute received power as well as the relative received power compared to the interference in the cell. The eNB will consider a preamble detected if the received signal power compared to the interference is above an eNB known threshold.

The UE performs power ramping in order to ensure that a UE can be detected even if the initially estimated transmission power of the preamble is not adequate. Another preamble will most likely be transmitted if no ACK or NACK is received by the UE before the next random access attempt. The transmit power of the preamble can be increased, and/or the preamble can be transmitted on a different UL frequency in order to increase the probability of detection. Therefore, the actual transmit power of the preamble that will be detected does not necessarily correspond to the initial transmit power of the preamble as initially calculated by the UE.

The UE must determine the possible UL transport format. The transport format, which may include MCS and a number of resource blocks that should be used by the UE, depends mainly on two parameters, specifically the SNR at the eNB and the required size of the message to be transmitted.

In practice, a maximum UE message size, or payload, and a required minimum SNR correspond to each transport format. In UMTS, the UE determines before the transmission of the preamble whether a transport format can be chosen for the transmission according to the estimated initial preamble transmit power, the required offset between preamble and the transport block, the maximum allowed or available UE transmit power, a fixed offset and additional margin. The preamble in UMTS need not contain any information regarding the transport format selected by the EU since the network does not need to reserve time and frequency resources and, therefore, the transport format is indicated together with the transmitted message.

The eNB must be aware of the size of the message that the UE intends to transmit and the SNR achievable by the UE in order to select the correct transport format upon reception of the preamble and then reserve the necessary time and frequency resources. Therefore, the eNB cannot estimate the SNR achievable by the EU according to the received preamble because the UE transmit power compared to the maximum allowed or possible UE transmit power is not known to the eNB, given that the UE will most likely consider the measured path loss in the DL or some equivalent measure for the determination of the initial preamble transmission power.

The eNB could calculate a difference between the path loss estimated in the DL compared and the path loss of the UL. However, this calculation is not possible if power ramping is used and the UE transmit power for the preamble does not correspond to the initially calculated UE transmit power. Furthermore, the precision of the actual UE transmit power and the transmit power at which the UE is intended to transmit is very low. Therefore, it has been proposed to code the path loss or CQI estimation of the downlink and the message size or the cause value in the UL in the signature.

Small cells using low power nodes are considered promising to cope with mobile traffic explosion, especially for hotspot deployments in indoor and outdoor scenarios. A low-power node generally means a node whose transmission (Tx) power is lower than macro node and base station (BS) classes, for example a pico and femto eNodeB (eNB) are both applicable. Small cell enhancements for the 3GPP LTE will focus on additional functionalities for enhanced performance in hotspot areas for indoor and outdoor using low power nodes.

In order to accommodate heavily-increased data traffic of a mobile communication system, small cell enhancements have been discussed. Specifically, for one feature of the small cell enhancements, dual connectivity has been discussed. Dual connectivity is an operation where a given user equipment (UE) consumes radio resources provided by at least two different network points (master eNB (MeNB) and secondary eNB (SeNB)) connected with non-ideal backhaul while in RRC_CONNECTED. Furthermore, each eNB involved in dual connectivity for a UE may assume different roles. Those roles do not necessarily depend on the eNB's power class and can vary among UEs.

The MeNB is an eNB which terminates at least S1-MME and therefore act as mobility anchor towards the CN in dual connectivity. If a macro eNB exists, the macro eNB may function as the MeNB, generally. The SeNB is an eNB providing additional radio resources for the UE, which is not the MeNB, in dual connectivity. An Xn interface may be defined between the MeNB and SeNB, and through the Xn interface, functions related to connectivity of a small cell can be performed. It is generally assumed that when the Xn interface exists, an X2 interface also exists. Bearer split refers to the ability to split a bearer over multiple eNBs in dual connectivity.

When the UE supports dual connectivity and moves, a situation that handover of the SeNB is only required while connection with the MeNB is maintained may occur. In this case, a method for performing a handover for dual connectivity effectively may be required.

### SUMMARY OF THE INVENTION

The present invention provides a method and apparatus for performing a handover procedure for dual connectivity in a wireless communication system. The present invention provides a method for performing a handover of a secondary eNodeB (SeNB) through a master eNB (MeNB), when a UE supports dual connectivity and the SeNB has a radio resource control (RRC) entity of the UE.

In an aspect, a method for performing, by a master eNodeB (MeNB) in dual connectivity, a handover procedure in a wireless communication system is provided. The method includes upon receiving a measurement report, performing a handover decision from a source secondary eNB (SeNB) to a target SeNB, transmitting an offloading request message, which includes contexts of E-UTRAN radio access bearers (E-RABs) to be offloaded and an offloading indication, to the target SeNB, receiving an offloading request acknowledge message, which includes identifiers (IDs) of E-RABs accepted by the target SeNB, as a response to the offloading request message from the target SeNB, and transmitting an offloading mobility indication to a user equipment (UE).

In another aspect, a method for performing, by a target secondary eNodeB (SeNB) in dual connectivity, a handover procedure in a wireless communication system is provided. The method includes receiving an offloading request message, which includes contexts of E-UTRAN radio access bearers (E-RABs) to be offloaded and an offloading indication, from a master eNB (MeNB) in dual connectivity, performing an admission control, transmitting an offloading request acknowledge message, which includes identifiers (IDs) of E-RABs accepted by the target SeNB, as a response to the offloading request message to the MeNB, and receiving a sequence number (SN) status transfer message, which includes an uplink (UL)/downlink (DL) packet data convergence protocol (PDCP) sequence number (SN) status and a hyper number (HFN) status for E-RABs to be offloaded, from the MeNB, and transmitting a handover notification message which informs that the UE has taken a configuration of the target SeNB into use.

In another aspect, a method for performing, by a source secondary eNodeB (SeNB) in dual connectivity, a handover procedure in a wireless communication system is provided. The method includes receiving an offloading notification message, which includes an indication that E-UTRAN radio access bearers (E-RABs) of a user equipment (UE) is to be offloaded, from a master eNB (MeNB) in dual connectivity, transmitting an offloading notification acknowledge message, which includes an uplink (UL)/downlink (DL) packet data convergence protocol (PDCP) sequence number (SN) status and a hyper number (HFN) status for E-RABs to be offloaded, as a response to the offloading notification message to the MeNB, and receiving a UE context release message from the MeNB.

Handover of a UE can be performed effectively in dual connectivity by changing only an SeNB while connection of an MeNB and the UE is maintained.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack and a control plane protocol stack of an LTE system.

FIG. 4 shows an example of a physical channel structure.

FIG. 5 shows deployment scenarios of small cells with/without macro coverage.

FIG. 6 shows an example of an inter-node radio resource aggregation.

FIG. 7 shows architecture of a control plane for dual connectivity.

FIGS. 8 and 9 show an intra-MME/S-GW handover procedure.

FIG. 10 shows an example of a handover between SeNBs in dual connectivity.

FIG. 11 and FIG. 12 show an example of a method for performing a handover procedure for dual connectivity according to an embodiment of the present invention.

FIG. 13 shows a wireless communication system to implement an embodiment of the present invention.

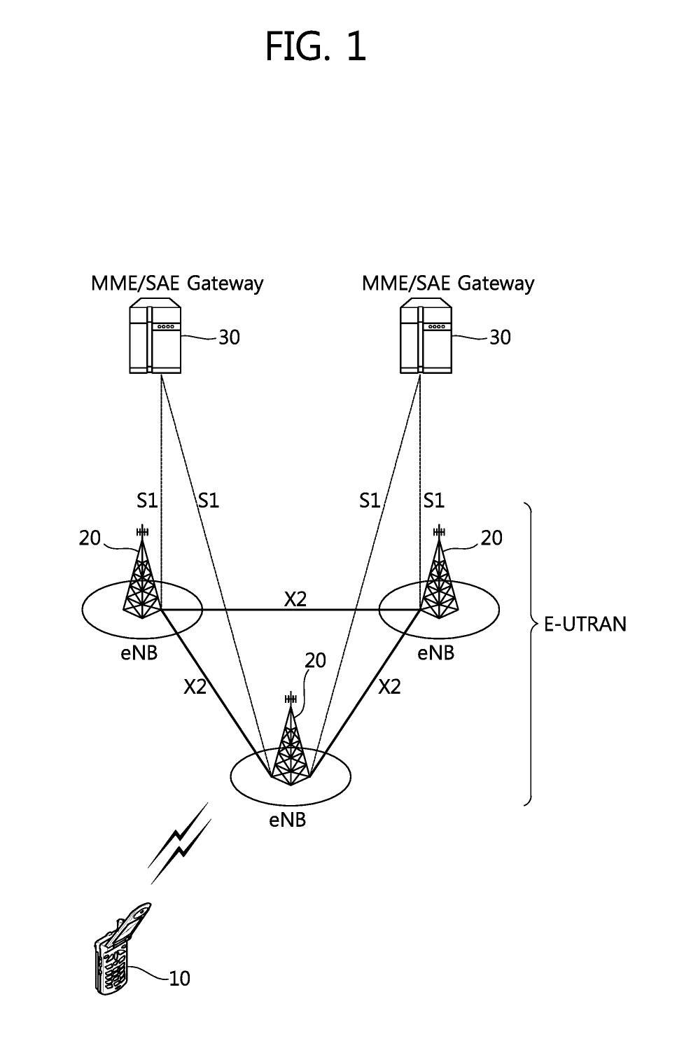

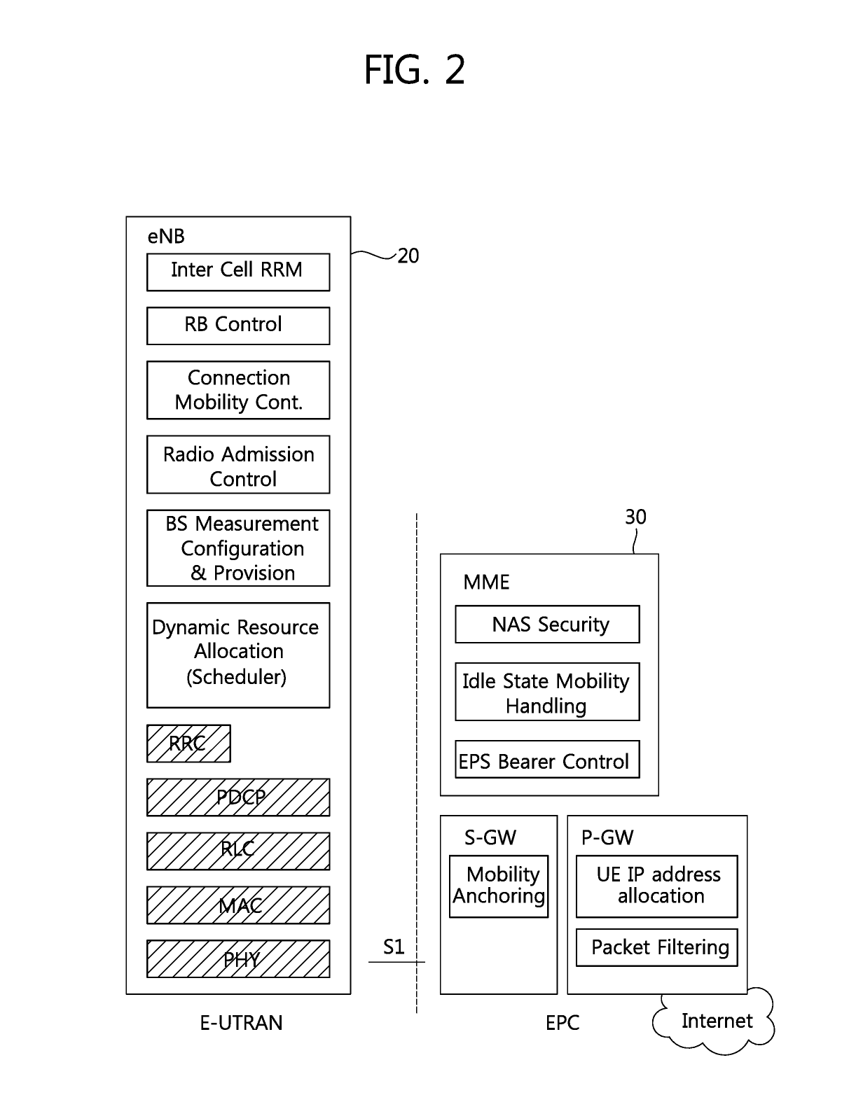

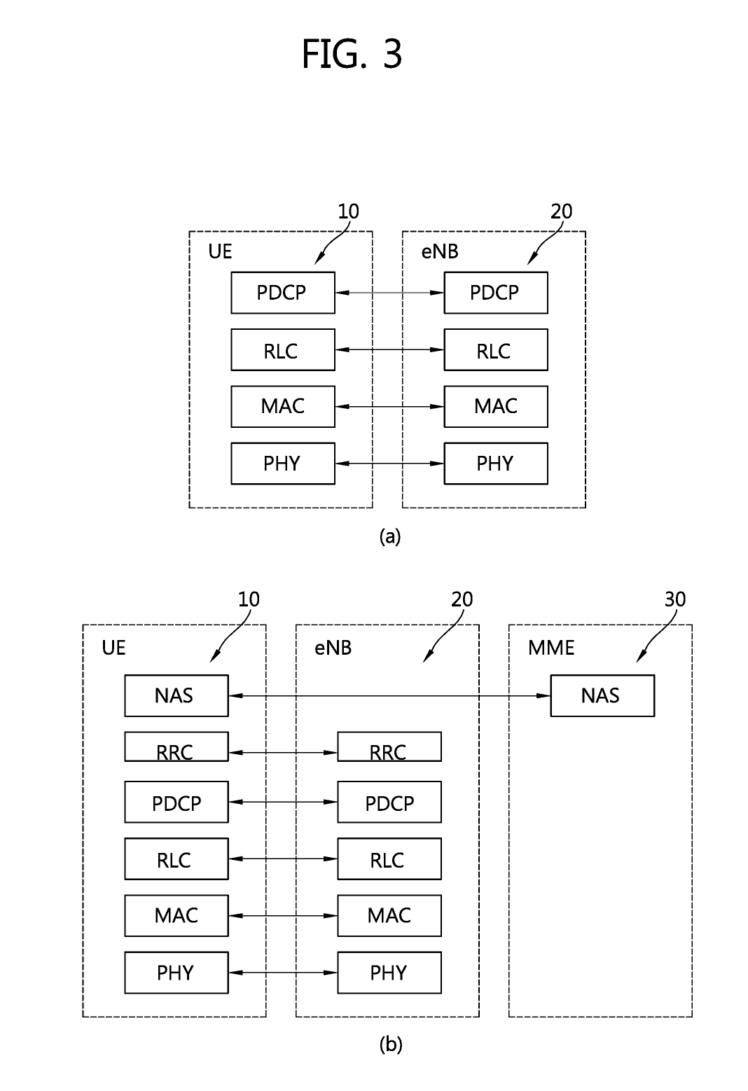

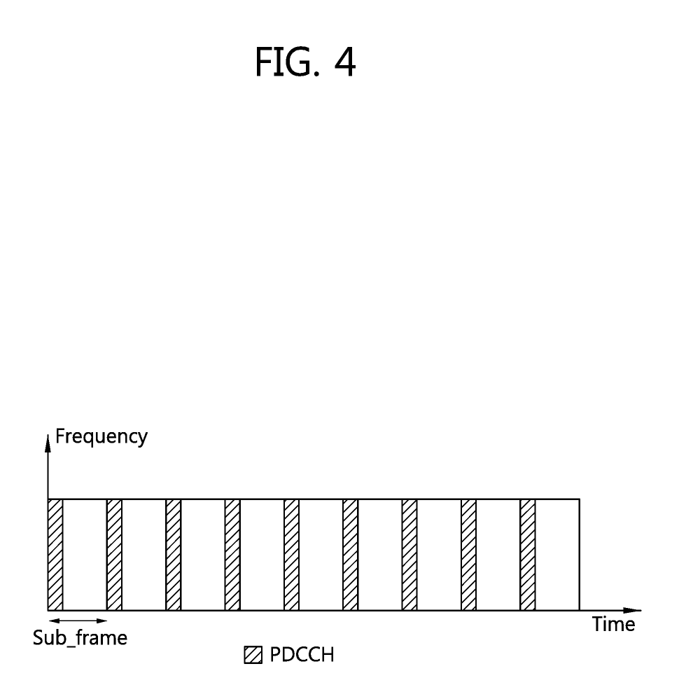

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

Small cell enhancement is described. It may be referred to 3GPP TR 36.932 V12.0.0 (2012-12).

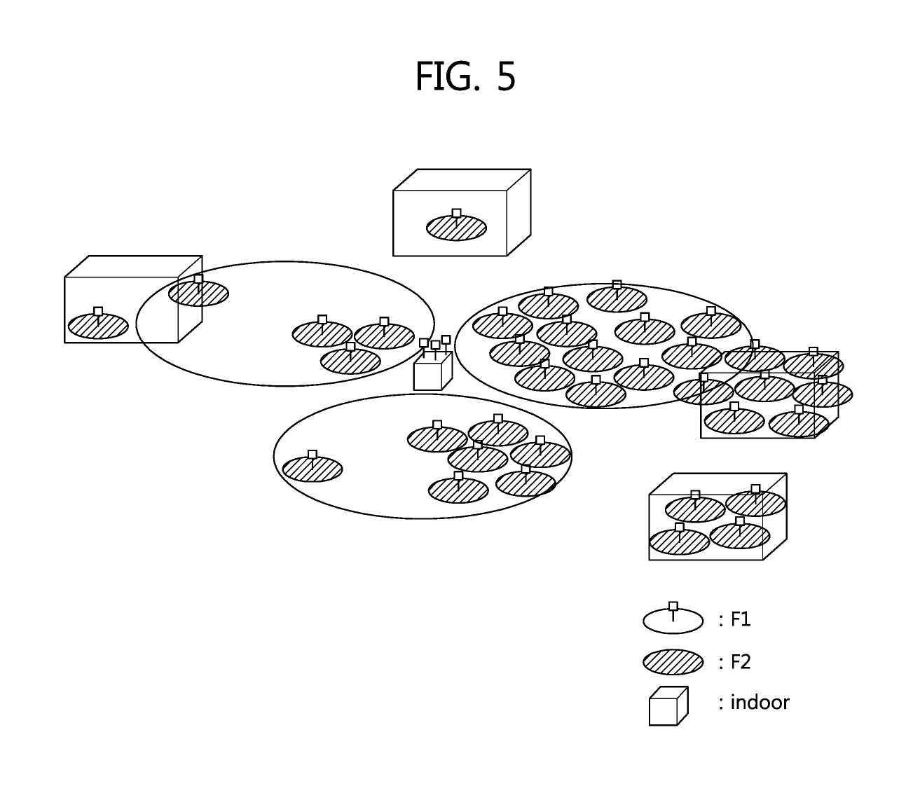

FIG. 5 shows deployment scenarios of small cells with/without macro coverage. Small cell enhancement should target both with and without macro coverage, both outdoor and indoor small cell deployments and both ideal and non-ideal backhaul. Both sparse and dense small cell deployments should be considered.

Referring to FIG. 5, small cell enhancement should target the deployment scenario in which small cell nodes are deployed under the coverage of one or more than one overlaid E-UTRAN macro-cell layer(s) in order to boost the capacity of already deployed cellular network. Two scenarios can be considered:
where the UE is in coverage of both the macro cell and the small cell simultaneously
where the UE is not in coverage of both the macro cell and the small cell simultaneously.

Also, the deployment scenario where small cell nodes are not deployed under the coverage of one or more overlaid E-UTRAN macro-cell layer(s) may be considered.

Small cell enhancement should target both outdoor and indoor small cell deployments. The small cell nodes could be deployed indoors or outdoors, and in either case could provide service to indoor or outdoor UEs.

For indoor UE, only low UE speed (0-3 km/h) is targeted. For outdoor, not only low UE speed, but also medium UE speed (up to 30 km/h and potentially higher speeds) is targeted.

Both throughput and mobility/connectivity shall be used as performance metric for both low and medium mobility. Cell edge performance (e.g. 5%-tile CDF point for user throughput) and power efficiency (of both network and UE) are also used as metrics.

Both ideal backhaul (i.e., very high throughput and very low latency backhaul such as dedicated point-to-point connection using optical fiber, line-of-sight (LOS) microwave) and non-ideal backhaul (i.e., typical backhaul widely used in the market such as xDSL, non-LOS (NLOS) microwave, and other backhauls like relaying) should be studied. The performance-cost trade-off should be taken into account.

For interfaces between macro and small cell, as well as between small cells, the studies should first identify which kind of information is needed or beneficial to be exchanged between nodes in order to get the desired improvements before the actual type of interface is determined. And if direct interface should be assumed between macro and small cell, as well as between small cell and small cell, X2 interface can be used as a starting point.

Small cell enhancement should consider sparse and dense small cell deployments. In some scenarios (e.g., hotspot indoor/outdoor places, etc), single or a few small cell node(s) are sparsely deployed, e.g., to cover the hotspot(s). Meanwhile, in some scenarios (e.g., dense urban, large shopping mall, etc), a lot of small cell nodes are densely deployed to support huge traffic over a relatively wide area covered by the small cell nodes. The coverage of the small cell layer is generally discontinuous between different hotspot areas. Each hotspot area can be covered by a group of small cells, i.e., a small cell cluster.

Furthermore, smooth future extension/scalability (e.g., from sparse to dense, from small-area dense to large-area dense, or from normal-dense to super-dense) should be considered. For mobility/connectivity performance, both sparse and dense deployments should be considered with equal priority.

Both synchronized and un-synchronized scenarios should be considered between small cells as well as between small cells and macro cell(s). For specific operations, e.g., interference coordination, carrier aggregation and inter-eNB coordinated multi-point (COMP), small cell enhancement can benefit from synchronized deployments with respect to small cell search/measurements and interference/resource management. Therefore time synchronized deployments of small cell clusters are prioritized in the study and new means to achieve such synchronization shall be considered.

Dual connectivity is described. It may be referred to 3GPP TR 36.842 V0.2.0 (2013-05).

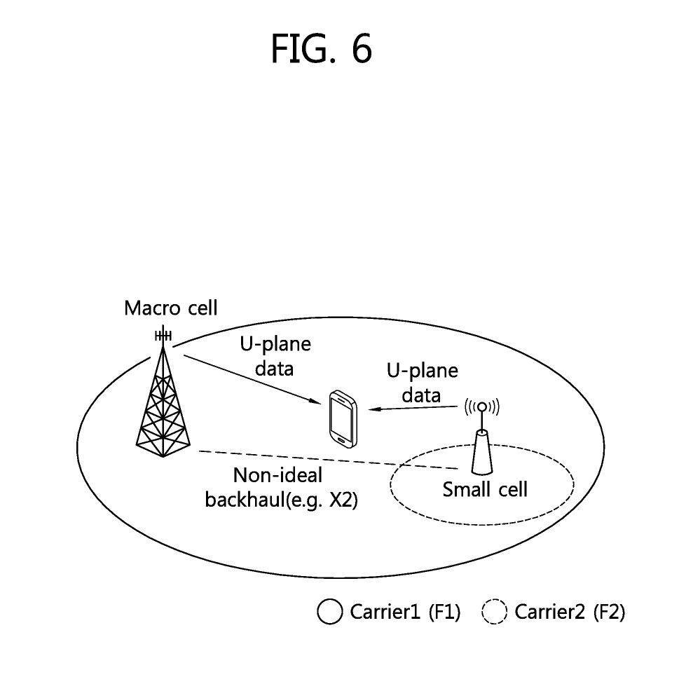

FIG. 6 shows an example of an inter-node radio resource aggregation. In the form of dual connectivity, various potential solutions can be considered. Specifically, inter-node radio resource aggregation is a potential solution for improving per-user throughput. This can be done by aggregating radio resources in more than one eNB for user plane data transmission. Depending on realization of this solution, signaling overhead towards the CN can potentially be saved by keeping the mobility anchor in the macro cell.

Control plane architecture for dual connectivity is described.

At least the following RRC functions are relevant when considering adding small cell layer to the UE for dual connectivity operation:
Small cell layer's common radio resource configurations
Small cell layer's dedicated radio resource configurations
Measurement and mobility control for small cell layer

In dual connectivity operation, a UE always stays in a single RRC state, i.e., either RRC_CONNECTED or RRC_IDLE. With this principle, the main two architecture alternatives for RRC are the following:
Option 1: Only the MeNB generates final RRC messages to be sent towards the UE after the coordination of radio resource management (RRM) functions between the MeNB and SeNB. The UE RRC entity sees all messages coming only from one entity (in the MeNB) and the UE only replies back to that entity.
Option 2: The MeNB and SeNB can generate final RRC messages to be sent towards the UE after the coordination of RRM functions between the MeNB and SeNB and may send those directly to the UE (depending on L2 architecture) and the UE replies accordingly.

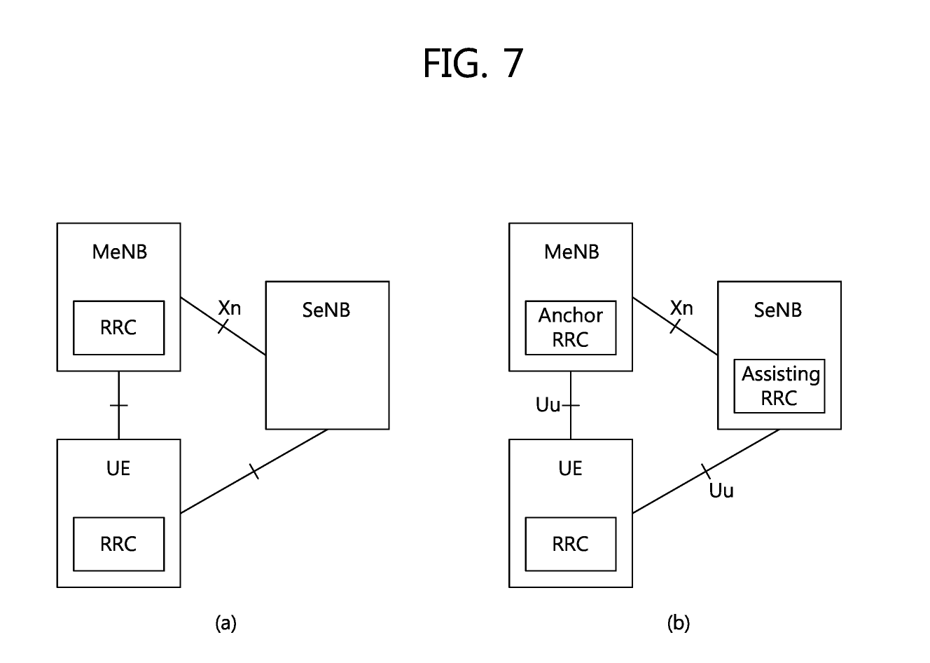

FIG. 7 shows architecture of a control plane for dual connectivity. FIG. 7 shows methods for splitting the control plane in dual connectivity. FIG. 7-(a) shows a case in which only the MeNB has an RRC entity for the UE, which corresponds to the option 1 above. In this case, since there is no RRC entity for the UE in the SeNB, radio resource configuration for the UE of the SeNB should be performed through the MeNB. FIG. 7-(b) shows a case in which both the MeNB and SeNB have RRC entities for the UE, which corresponds to the option 2 above. The MeNB has an anchor RRC entity for the UE, and the SeNB has an assisting RRC entity for the UE. In this case, the RRC entity in the SeNB may perform radio resource configuration for the UE of the SeNB.

Handover (HO) is described. It may be referred to Section 10.1.2.1 of 3GPP TS 36.300 V11.4.0 (2012-12).

The intra E-UTRAN HO of a UE in RRC_CONNECTED state is a UE-assisted network-controlled HO, with HO preparation signaling in E-UTRAN:
Part of the HO command comes from the target eNB and is transparently forwarded to the UE by the source eNB;
To prepare the HO, the source eNB passes all necessary information to the target eNB (e.g., E-UTRAN radio access bearer (E-RAB) attributes and RRC context): When carrier aggregation (CA) is configured and to enable secondary cell (SCell) selection in the target eNB, the source eNB can provide in decreasing order of radio quality a list of the best cells and optionally measurement result of the cells.
Both the source eNB and UE keep some context (e.g., C-RNTI) to enable the return of the UE in case of HO failure;
UE accesses the target cell via RACH following a contention-free procedure using a dedicated RACH preamble or following a contention-based procedure if dedicated RACH preambles are not available: the UE uses the dedicated preamble until the handover procedure is finished (successfully or unsuccessfully);
If the RACH procedure towards the target cell is not successful within a certain time, the UE initiates radio link failure recovery using the best cell;
No robust header compression (ROHC) context is transferred at handover.

The preparation and execution phase of the HO procedure is performed without EPC involvement, i.e., preparation messages are directly exchanged between the eNBs. The release of the resources at the source side during the HO completion phase is triggered by the eNB. In case an RN is involved, its donor eNB (DeNB) relays the appropriate S1 messages between the RN and the MME (S1-based handover) and X2 messages between the RN and target eNB (X2-based handover); the DeNB is explicitly aware of a UE attached to the RN due to the S1 proxy and X2 proxy functionality.

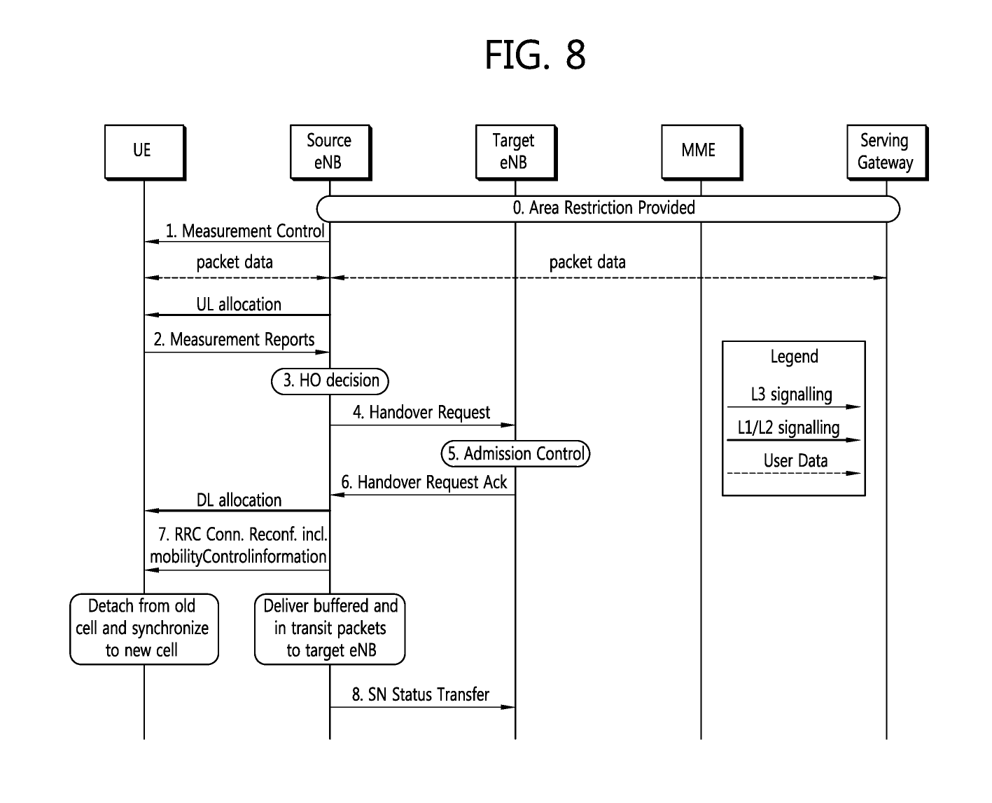

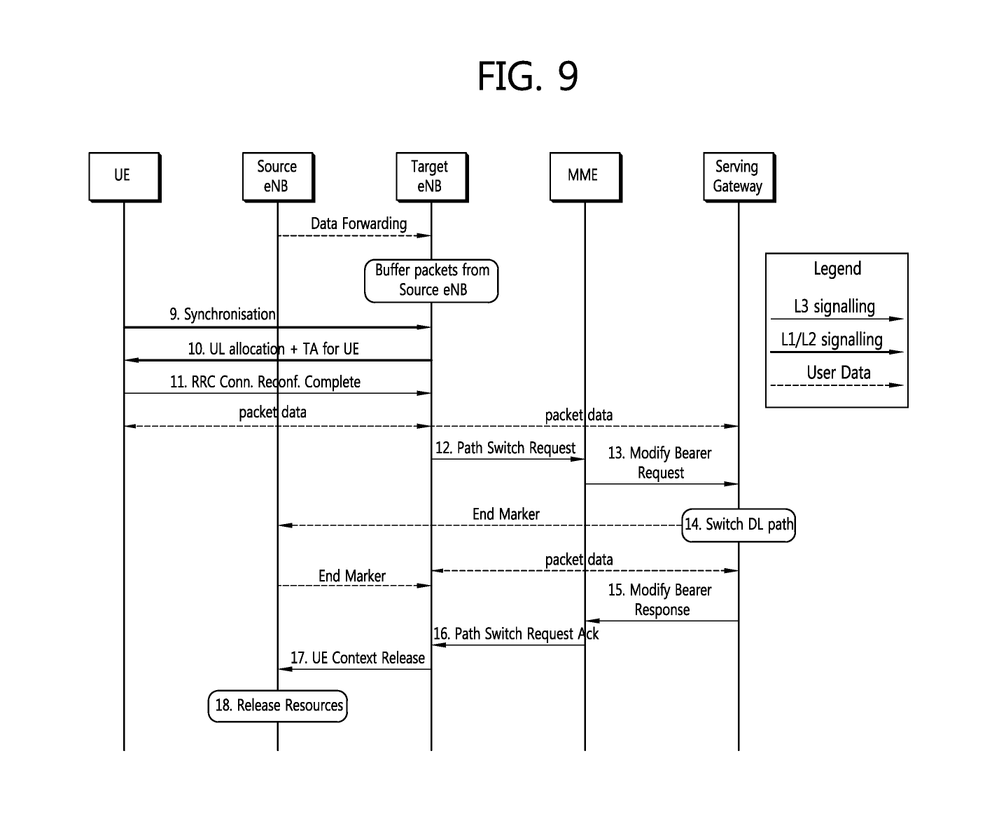

FIGS. 8 and 9 show an intra-MME/S-GW handover procedure.

0. The UE context within the source eNB contains information regarding roaming restrictions which were provided either at connection establishment or at the last TA update.

1. The source eNB configures the UE measurement procedures according to the area restriction information. Measurements provided by the source eNB may assist the function controlling the UE's connection mobility.

2. The UE is triggered to send measurement reports by the rules set by i.e., system information, specification, etc.

3. The source eNB makes decision based on measurement reports and radio resource management (RRM) information to hand off the UE.

4. The source eNB issues a handover request message to the target eNB passing necessary information to prepare the HO at the target side (UE X2 signalling context reference at source eNB, UE S1 EPC signalling context reference, target cell identifier (ID), K_{eNB}*, RRC context including the cell radio network temporary identifier (C-RNTI) of the UE in the source eNB, AS-configuration, E-RAB context and physical layer ID of the source cell+short MAC-I for possible radio link failure (RLF) recovery). UE X2/UE S1 signalling references enable the target eNB to address the source eNB and the EPC. The E-RAB context includes necessary radio network layer (RNL) and transport network layer (TNL) addressing information, and quality of service (QoS) profiles of the E-RABs.

5. Admission Control may be performed by the target eNB dependent on the received E-RAB QoS information to increase the likelihood of a successful HO, if the resources can be granted by target eNB. The target eNB configures the required resources according to the received E-RAB QoS information and reserves a C-RNTI and optionally a RACH preamble. The AS-configuration to be used in the target cell can either be specified independently (i.e., an “establishment”) or as a delta compared to the AS-configuration used in the source cell (i.e., a “reconfiguration”).

6. The target eNB prepares HO with L1/L2 and sends the handover request acknowledge to the source eNB. The handover request acknowledge message includes a transparent container to be sent to the UE as an RRC message to perform the handover. The container includes a new C-RNTI, target eNB security algorithm identifiers for the selected security algorithms, may include a dedicated RACH preamble, and possibly some other parameters, i.e., access parameters, SIBs, etc. The handover request acknowledge message may also include RNL/TNL information for the forwarding tunnels, if necessary.

As soon as the source eNB receives the handover request acknowledge, or as soon as the transmission of the handover command is initiated in the downlink, data forwarding may be initiated.

Steps 7 to 16 in FIGS. 8 and 9 provide means to avoid data loss during HO.

7. The target eNB generates the RRC message to perform the handover, i.e., RRCConnectionReconfiguration message including the mobilityControlInformation, to be sent by the source eNB towards the UE. The source eNB performs the necessary integrity protection and ciphering of the message. The UE receives the RRCConnectionReconfiguration message with necessary parameters (i.e. new C-RNTI, target eNB security algorithm identifiers, and optionally dedicated RACH preamble, target eNB SIBs, etc.) and is commanded by the source eNB to perform the HO. The UE does not need to delay the handover execution for delivering the HARQ/ARQ responses to source eNB.

8. The source eNB sends the sequence number (SN) status transfer message to the target eNB to convey the uplink PDCP SN receiver status and the downlink PDCP SN transmitter status of E-RABs for which PDCP status preservation applies (i.e., for RLC AM). The uplink PDCP SN receiver status includes at least the PDCP SN of the first missing UL service data unit (SDU) and may include a bit map of the receive status of the out of sequence UL SDUs that the UE needs to retransmit in the target cell, if there are any such SDUs. The downlink PDCP SN transmitter status indicates the next PDCP SN that the target eNB shall assign to new SDUs, not having a PDCP SN yet. The source eNB may omit sending this message if none of the E-RABs of the UE shall be treated with PDCP status preservation.

9. After receiving the RRCConnectionReconfiguration message including the mobilityControlInformation, UE performs synchronization to target eNB and accesses the target cell via RACH, following a contention-free procedure if a dedicated RACH preamble was indicated in the mobilityControlInformation, or following a contention-based procedure if no dedicated preamble was indicated. UE derives target eNB specific keys and configures the selected security algorithms to be used in the target cell.

10. The target eNB responds with UL allocation and timing advance.

11. When the UE has successfully accessed the target cell, the UE sends the RRCConnectionReconfigurationComplete message (C-RNTI) to confirm the handover, along with an uplink buffer status report, whenever possible, to the target eNB to indicate that the handover procedure is completed for the UE. The target eNB verifies the C-RNTI sent in the RRCConnectionReconfigurationComplete message. The target eNB can now begin sending data to the UE.

12. The target eNB sends a path switch request message to MME to inform that the UE has changed cell.

13. The MME sends a modify bearer request message to the serving gateway.

14. The serving gateway switches the downlink data path to the target side. The Serving gateway sends one or more “end marker” packets on the old path to the source eNB and then can release any U-plane/TNL resources towards the source eNB.

15. The serving gateway sends a modify bearer response message to MME.

16. The MME confirms the path switch request message with the path switch request acknowledge message.

17. By sending the UE context release message, the target eNB informs success of HO to source eNB and triggers the release of resources by the source eNB. The target eNB sends this message after the path switch request acknowledge message is received from the MME.

18. Upon reception of the UE context release message, the source eNB can release radio and C-plane related resources associated to the UE context. Any ongoing data forwarding may continue.

As described above, in dual connectivity, the MeNB terminates S1-MME and act as mobility. The SeNB provides additional radio resources for the UE. Accordingly, additional resources can be utilized in dual connectivity by using the SeNB to which data is offloaded from the MeNB, while only one eNB serves the UE in the prior art. Meanwhile, when the UE moves while being connected with both the MeNB and SeNB in dual connectivity, only the connection with the SeNB may be handed over to another SeNB, while the connection with the MeNB is maintained.

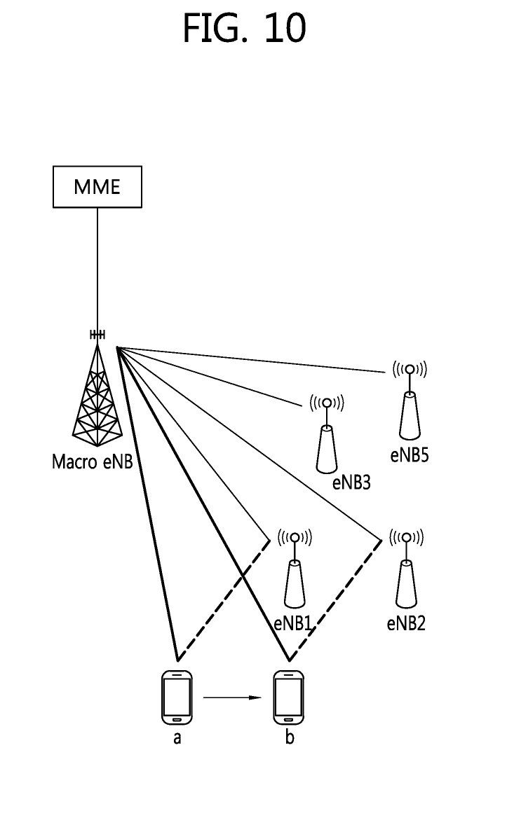

FIG. 10 shows an example of a handover between SeNBs in dual connectivity.

Referring to FIG. 10, a UE supports dual connectivity, and accordingly, has connections with both a macro eNB and eNB 1. The macro eNB functions as an MeNB in dual connectivity. The eNB 1 functions as an SeNB in dual connectivity, and serves a small cell. Each of eNB 2 to eNB 5 also serves a small cell, respectively.

It is assumed that the UE moves from location ‘a’ to location ‘b’. After the UE moves, for dual connectivity, only the SeNB in dual connectivity may need to be changed from the eNB 1 to the eNB 2, while the macro eNB still functions as the MeNB in dual connectivity. That is, only the connection with the eNB 1 (source eNB) may be handed over to the eNB 2 (target eNB), while the connection with the MeNB is maintained. The eNB 2 newly functions as the SeNB. Accordingly, dual connectivity may consist of the connection with the macro eNB and the connection with the eNB 2. However, a method for performing handover only for the SeNB in dual connectivity has not yet defined in the prior art.

Hereinafter, a method for performing a handover procedure for dual connectivity according to embodiments of the present invention is described. According to embodiments of the present invention, when the UE supports dual connectivity with the MeNB and SeNB, a method for performing handover of the SeNB through the MeNB is proposed. At this time, the connection with the MeNB is maintained.

In the description below, it is assumed that a macro eNB functions as the MeNB in dual connectivity and a small eNB functions as the SeNB in dual connectivity. Further, it is assumed that the MeNB and SeNBs are connected with each other via the Xn interface. Further, it is assumed that if the Xn interface exists, the X2 interface also exists.

According to an embodiment of the present invention, for performing a handover procedure for dual connectivity, the MeNB may deliver messages required for the handover procedure between a source SeNB and a target SeNB, and accordingly, may change RRC configuration for the UE. More specifically, according to an embodiment of the present invention, the MeNB may transmit a request message for handover to the target SeNB. The handover request message may includes an indication, which indicates that the handover is for data offloading based on dual connectivity, and identifiers (IDs) of E-RABs to be offloaded. Upon receiving the request message, the target SeNB may transmit an acknowledge message to the MeNB. The acknowledge message may include IDs of E-RABS that the target SeNB can accept. Upon receiving the acknowledge message, the MeNB may inform the UE of DRBs to be handed over. If the target SeNB accepts all of E-RABs requested by the MeNB, the MeNB may inform the UE of the corresponding DRBs. If the target SeNB accepts only a part of E-RABs requested by the MeNB, for E-RABs which are accepted by the target SeNB and are to be handed over, the MeNB may inform the UE of corresponding DRBs with an RRC configuration of the target SeNB. For E-RABs which are not accept by the target SeNB and are not to be handed over, the MeNB may inform the UE of corresponding DRBs with an RRC configuration of the MeNB for handover to the MeNB.

Further, according to an embodiment of the present invention, during a handover procedure from the source SeNB to the target SeNB, the MeNB may inform the source SeNB that data offloading is to be performed from the source SeNB to the target SeNB. As a response, the source SeNB may transmit an acknowledgement message to the MeNB. The acknowledgement message may include a UL/DL PDCP SN status and a hyper frame number (HFN) status for data that the source SeNB transmits to the UE. Upon receiving the acknowledgement message, the MeNB may transmit these statuses to the target SeNB.

Further, according to an embodiment of the present invention, after the handover procedure is completed, the target SeNB may inform the MeNB that the handover procedure is completed. Upon receiving this message, the MeNB may command the source SeNB to release contexts of corresponding UEs.

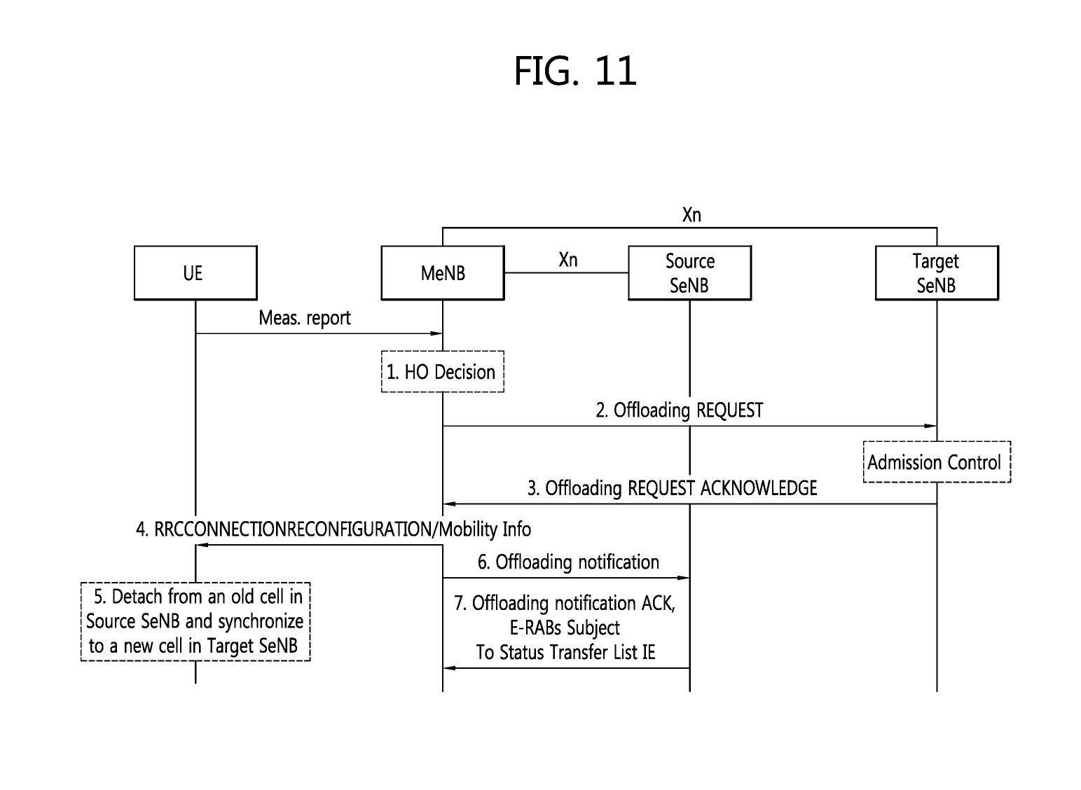

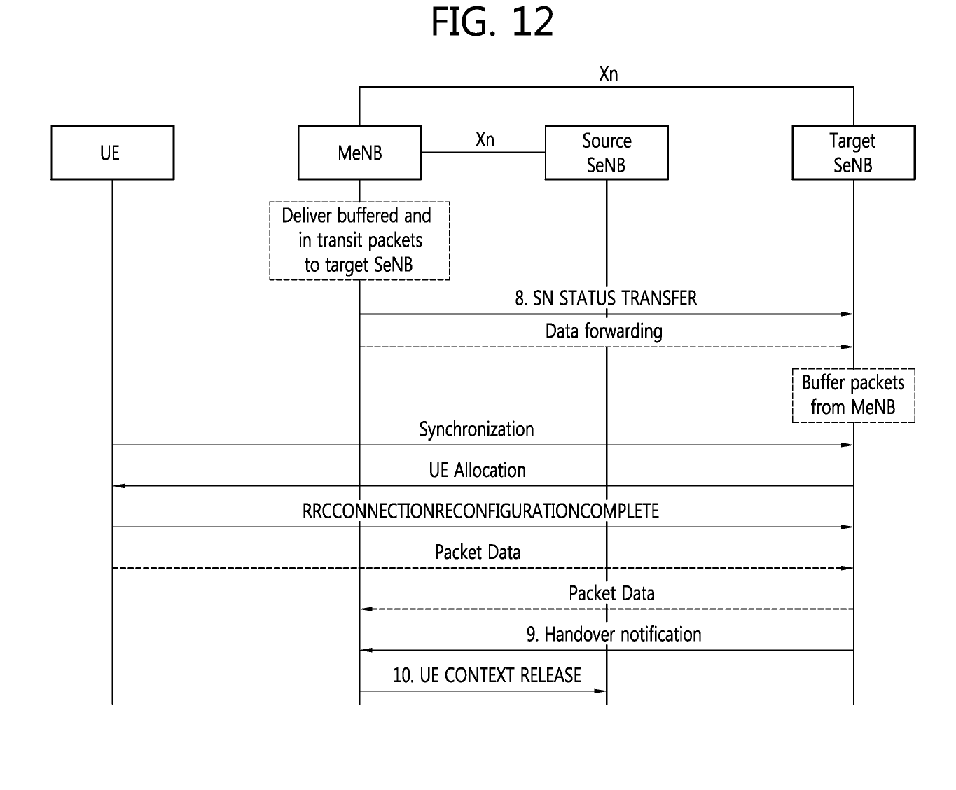

FIG. 11 and FIG. 12 show an example of a method for performing a handover procedure for dual connectivity according to an embodiment of the present invention. It is assumed that eNBs, which provide dual connectivity for the UE, manage an ID of the UE by allocating eNB UE X2 ID to the UE.

First, FIG. 11 is described.

1. Upon receiving a measurement report from the UE, the MeNB performs a handover decision. Accordingly, the MeNB determines that data service performed through the source SeNB is to be handed over to the target SeNB. The decision of the handover from the source SeNB to the target SeNB may be determined by using the conventional method, or may be determined by defining a new threshold for a handover of a small cell.

2. The MeNB transmits an offloading request message to the target SeNB. The offloading request message may be transmitted by using the conventional handover request message, described in FIG. 8 above. Or, the offloading request message may be newly defined. The offloading request message may include information included in the conventional handover request message. That is, the offloading request message may include such information, i.e., UE X2 signalling context reference at source eNB, UE S1 EPC signalling context reference, target ID, K_{eNB}*, RRC context including the C-RNTI of the UE in the source eNB, AS-configuration, E-RAB context and physical layer ID of the source cell+short MAC-I for possible RLF recovery, and DL forwarding. The E-RAB context is a context of E-RABs to be offloaded. Further, the offloading request message may include an offloading indication which indicates that this handover procedure is for data offloading from the source SeNB to the target SeNB. UE X2 ID may be generated in order to represent the ID of the UE.

3. Upon receiving the offloading request message, The target SeNB performs an admission control, and transmits an offloading request acknowledge message to the MeNB. If the offloading request message is transmitted by using the conventional X2 handover request message, the offloading request acknowledge message may be transmitted by using the conventional handover request acknowledge message. If the offloading request message is transmitted by using a newly defined message, the offloading request acknowledge message may also be newly defined. The offloading request acknowledge message may include information included in the conventional handover request acknowledge message. That is, the offloading request acknowledge message may include such information, i.e., a transparent container including a new C-RNTI, target eNB security algorithm identifiers for the selected security algorithms, a dedicated RACH preamble, access parameters, SIBs, etc. Further, the offloading request acknowledge message may include IDs of E-RABs accept by the target SeNB. Table 1 below shows an example of the offloading request acknowledge message. Referring to Table 1, the new eNB UE X2 ID indicates an identifier which the target SeNB represents the UE for the X2 interface.

TABLE 1

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.1.1 | | YES | reject |
| Old eNB UE X2 ID | M | | XXXX | | YES | ignore |
| New eNB UE X2 ID | M | | XXXX | | YES | ignore |
| E-RAB Setup List | | 0 . . . 1 | | | YES | ignore |
| >E-RAB Setup | | 1 . . . <maxnoof | | | EACH | ignore |
| Item Ies | | E-RABs> | | | | |
| >>E-RAB ID | M | | | | — | |
| >>Transport | M | | 9.2.2.1 | | — | |
| Layer Address | | | | | | |
| >>GTP-TEID | M | | 9.2.2.2 | eNB | — | |
| | | | | TEID. | | |
| E-RAB Failed to | O | | E-RAB | A value | YES | ignore |
| Setup List | | | List | for E- | | |
| | | | 9.2.1.36 | RAB ID | | |
| | | | | shall only | | |
| | | | | be present | | |
| | | | | once in | | |
| | | | | E-RAB | | |
| | | | | Setup List | | |
| | | | | IE + in | | |
| | | | | E-RAB | | |
| | | | | Failed to | | |
| | | | | Setup List | | |
| | | | | IE. | | |
| Criticality | O | | 9.2.1.21 | | YES | ignore |
| Diagnostics | | | | | | |

4. Upon receiving the offloading request acknowledge message, the MeNB inform the UE that a handover procedure for data offloading is to be performed. For this, the RRCconnectionreconfiguration message may be used. Or, a newly defined message may be used to inform the UE that handover procedure for data offloading is to be performed. The newly defined message or the RRCconnectionreconfiguration message may include an offloading mobility indication. The offloading mobility indication indicates that some RBs are offloaded to the small cell. The newly defined message or the RRCconnectionreconfiguration message may further include a dedicated radio resource configuration. The dedicated radio resource configuration may include information on RBs to be offloaded by using DRB-ToRelease list.

5. The UE detaches from an old cell in the source SeNB and synchronize to a new cell in the target SeNB. The UE performs an RRC establishment to the new cell in the target SeNB for dual connectivity. At this time, the target SeNB may provide information on RBs to be offloaded by using the RRCconnectionreconfiguration message. The information on RBs to be offloaded may include information included in DRB-ToAddMod shown in Table 2.

TABLE 2
DRB-ToAddMod ::= SEQUENCE {

| | | | |
|---|---|---|---|
| eps-BearerIdentity | INTEGER (0..15) | OPTIONAL, | -- Cond |
| DRB-Setup | | | |

| | | | |
|---|---|---|---|
| drb-Identity | DRB-Identity, | | |
| pdcp-Config | PDCP-Config | OPTIONAL, | -- Cond PDCP |
| rlc-Config | RLC-Config | OPTIONAL, | -- Cond Setup |

| | | | |
|---|---|---|---|
| logicalChannelIdentity | INTEGER (3..10) | OPTIONAL, | -- Cond |
| DRB-Setup | | | |

| | | | |
|---|---|---|---|
| logicalChannelConfig | LogicalChannelConfig | OPTIONAL, | -- Cond Setup |
| ... | | | |
| } | | | |

6. The MeNB transmits an offloading notification message to the source SeNB in order to inform the source SeNB that E-RABs of the UE are to be offloaded. In order to represent the corresponding UE, the offloading notification message may include of an UE X2 ID of the MeNB and an UE X2 ID of the source SeNB.

7. Upon receiving offloading notification message, the source SeNB transmits an offloading notification acknowledge message to the MeNB. Further, the source SeNB may transmit to the MeNB UL/DL PDCP SN status and HFN status for E-RABs to be offloaded by using E-RABs Subject To Status Transfer List IE. For this, the SN STATUS TRANSFER message may be transmitted, or the offloading notification acknowledge message may include the E-RABs Subject To Status Transfer List IE.

FIG. 12 is described by being continued from FIG. 11.

8. The MeNB delivers the buffered and in transit packets to the target SeNB. And, the MeNB transmits an SN STATUS TRANSFER message to the target SeNB. The SN STATUS TRANSFER message may include the UL/DL PDCP SN status and HFN status for E-RABs to be offloaded. The MeNB may forward data to the target SeNB, and the target SeNB may buffer packets received from the MeNB.

9. The UE and the target SeNB perform an RRC establishment. After the RRC establishment, the target SeNB transmits a handover notification message to the MeNB in order to inform the MeNB that the handover procedure is completed. The handover notification message may include an UE X2 ID of an old eNB (MeNB) and an UE X2 ID of a new eNB (target SeNB).

10. Upon receiving the handover notification message, the MeNB transmits a UE context release message to the source SeNB. The UE context release message may include an UE X2 ID of an old eNB (source SeNB) and an UE X2 ID of a new eNB (MeNB).

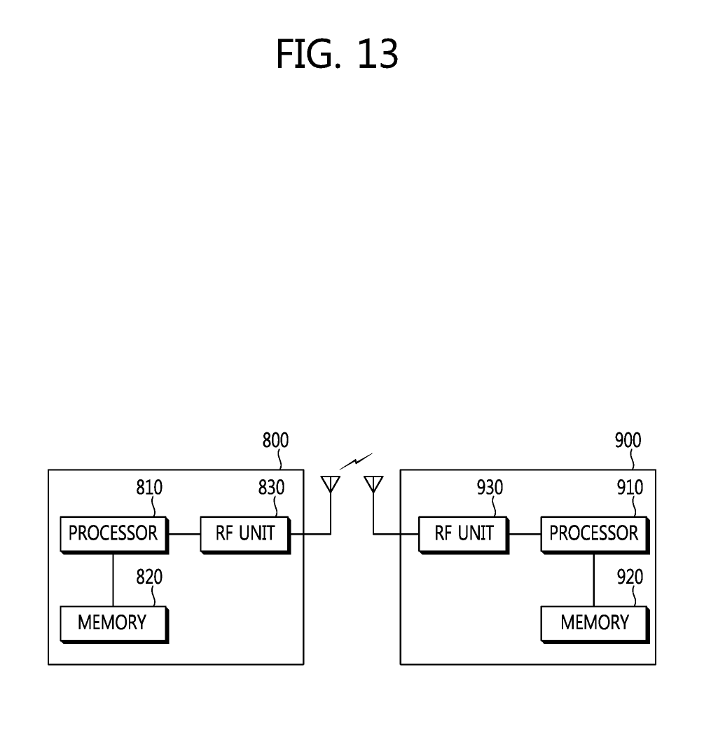

FIG. 13 shows a wireless communication system to implement an embodiment of the present invention.

An MeNB 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An SeNB or a UE 900 includes a processor 910, a memory 920 and an RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for performing, by a master eNodeB (MeNB) in dual connectivity, a handover procedure in a wireless communication system, the method comprising:
upon receiving a measurement report, performing a handover decision from a source secondary eNB (SeNB) to a target SeNB;
transmitting an offloading request message, which includes contexts of E-UTRAN radio access bearers (E-RABs) to be offloaded and an offloading indication, to the target SeNB;
receiving an offloading request acknowledge message, which includes identifiers (IDs) of E-RABs accepted by the target SeNB, as a response to the offloading request message from the target SeNB; and
transmitting an offloading mobility indication to a user equipment (UE).

2. The method of claim 1, wherein the handover decision is performed based on a new threshold defined for a handover of a small cell.

3. The method of claim 1, wherein the offloading indication indicates that the handover procedure is for data offloading.

4. The method of claim 1, wherein the offloading mobility indication indicates that some RBs are offloaded to a small cell.

5. The method of claim 1, wherein the offloading mobility indication is transmitted via a radio resource control (RRC) connection reconfiguration message or a newly defined message.

6. The method of claim 1, further comprising:
transmitting an offloading notification message, which includes an indication that E-RABs of the UE is to be offloaded, to the source SeNB.

7. The method of claim 6, wherein the offloading notification message includes a UE X2 ID of the MeNB and a UE X2 ID of the source SeNB.

8. The method of claim 6, further comprising:
receiving an offloading notification acknowledge message, which includes an uplink (UL)/downlink (DL) packet data convergence protocol (PDCP) sequence number (SN) status and a hyper number (HFN) status for E-RABs to be offloaded, as a response to the offloading notification message from the source SeNB.

9. The method of claim 8, further comprising:
transmitting an SN status transfer message, which includes the UL/DL PDCP SN status and the HFN status for E-RABs to be offloaded, to the target SeNB.

10. The method of claim 1, further comprising:
receiving a handover notification message which informs that the UE has taken a configuration of the target SeNB into use.

11. The method of claim 10, wherein the handover notification message includes a UE X2 ID of the MeNB and a UE X2 ID of the target SeNB.

12. The method of claim 1, further comprising:
transmitting a UE context release message to the source SeNB.

13. The method of claim 12, wherein the UE context release message includes a UE X2 ID of the MeNB and a UE X2 ID of the source SeNB.

14. A method for performing, by a target secondary eNodeB (SeNB) in dual connectivity, a handover procedure in a wireless communication system, the method comprising:
receiving an offloading request message, which includes contexts of E-UTRAN radio access bearers (E-RABs) to be offloaded and an offloading indication, from a master eNB (MeNB) in dual connectivity;
performing an admission control;
transmitting an offloading request acknowledge message, which includes identifiers (IDs) of E-RABs accepted by the target SeNB, as a response to the offloading request message to the MeNB; and
receiving a sequence number (SN) status transfer message, which includes an uplink (UL)/downlink (DL) packet data convergence protocol (PDCP) sequence number (SN) status and a hyper number (HFN) status for E-RABs to be offloaded, from the MeNB; and
transmitting a handover notification message which informs that the UE has taken a configuration of the target SeNB into use.

15. A method for performing, by a source secondary eNodeB (SeNB) in dual connectivity, a handover procedure in a wireless communication system, the method comprising:
receiving an offloading notification message, which includes an indication that E-UTRAN radio access bearers (E-RABs) of a user equipment (UE) is to be offloaded, from a master eNB (MeNB) in dual connectivity;
transmitting an offloading notification acknowledge message, which includes an uplink (UL)/downlink (DL) packet data convergence protocol (PDCP) sequence number (SN) status and a hyper number (HFN) status for E-RABs to be offloaded, as a response to the offloading notification message to the MeNB; and
receiving a UE context release message from the MeNB.
